(19) United States
(12) Patent Application Publication
(10) Pub. No.: US 2024/0097273 A1
(43) Pub. Date: Mar. 21, 2024

(54) NON-AQUEOUS ELECTROLYTE SECONDARY BATTERY

(71) Applicant: Toray Industries, Inc., Tokyo (JP)

(72) Inventors: Kei Ikoma, Otsu-shi, Shiga (JP); Aya Seita, Otsu-shi, Shiga (JP); Akimitsu Tsukuda, Otsu-shi, Shiga (JP)

(21) Appl. No.: 18/270,513

(22) PCT Filed: Mar. 29, 2022
(86) PCT No.: PCT/JP2022/015400

§ 371 Date: Jun. 30, 2023

(30) Foreign Application Priority Data
Mar. 31, 2021 (JP) 2021-059762

(51) Int. Cl. H01M 50/423; H01M 4/505; H01M 4/525; H01M 4/583; H01M 10/0569; H01M 50/497

(52) U.S. Cl. CPC H01M 50/423; H01M 4/505; H01M 4/525; H01M 4/583; H01M 10/0569; H01M 50/497; H01M 2004/028

(57) ABSTRACT

A non-aqueous electrolyte secondary battery including positive and negative electrodes, a non-aqueous electrolytic solution, and a separator, in which: an active material of the positive electrode is a lithium-containing transition metal oxide represented by LixMyOz, where M is at least one element selected from the group consisting of Ni, Co, Mn, Al, Mg, and Mo, and a composition ratio satisfies 0.8≤x≤1.3, 0.5≤y≤2, and 1≤z≤4; an active material of the negative electrode contains one or more compounds of a C-based compound, a Si-based compound, a Sn-based compound, and metal lithium; the non-aqueous electrolytic solution contains two solvents, is separated by the separator, and has a composition of the non-aqueous electrolytic solution in contact with a negative electrode side and a composition of the non-aqueous electrolytic solution in contact with a positive electrode side different from each other.

### TECHNICAL FIELD

This disclosure relates to a non-aqueous electrolyte secondary battery.

### BACKGROUND

Non-aqueous electrolyte secondary batteries such as lithium ion batteries are widely used in portable digital devices such as smartphones, tablets, mobile phones, notebook computers, digital cameras, digital video cameras, and portable game machines, portable devices such as power tools, electric motorcycles, and power-assisted bicycles, and automobile applications such as electric cars, hybrid cars, and plug-in hybrid cars.

A non-aqueous electrolyte secondary battery generally has a configuration in which a separator and a non-aqueous electrolytic solution are interposed between a positive electrode with a positive electrode active material stacked on a current collector and a negative electrode with a negative electrode active material stacked on a current collector.

As a separator, a polyolefin porous base material is generally used. Characteristics required for separators include a characteristic in which the separator contains an electrolytic solution in a porous structure so that ion movement is possible, and a shutdown characteristic in which if abnormal heat generation occurs in a non-aqueous electrolyte secondary battery, the material is melted by heat to close the porous structure so that ion movement is stopped and the battery ceases to function.

However, in recent years, a further increase in energy density is required for a non-aqueous electrolyte secondary battery, and in particular, studies have started on an increase in voltage for improving the electromotive force of the battery together with an increase in capacity by a positive electrode active material and a negative electrode active material.

To increase the voltage of a battery, oxidation resistance and reduction resistance of a solvent that forms a non-aqueous electrolytic solution are important. The oxidation resistance and reduction resistance of the solvent can be evaluated using the highest occupied molecular orbital (HOMO) energy and the lowest unoccupied molecular orbital (LUMO) energy according to the frontier orbital theory. The oxidizability of the solvent can be organized using the HOMO energy, and when the HOMO energy is negative and its absolute value is large, the solvent is hardly oxidized. On the other hand, the reducibility of the non-aqueous electrolytic solution can be organized using the LUMO energy, and when the LUMO energy is positive and its absolute value is large, the electrolyte is hardly reduced. However, in a solvent having a negative HOMO energy that is large in absolute value, the LUMO energy is positive, and the absolute value of the LUMO energy is not large. Therefore, it is substantially impossible to make the voltage of the battery 4.5 V or more because of the balance between oxidation resistance and reduction resistance of the solvent.

Therefore, it is important to solve the problem of the non-aqueous electrolytic solution by using two different non-aqueous electrolytic solutions in combination. As an approach to use two different non-aqueous electrolytic solutions in combination, Japanese Patent Laid-open Publication Nos. 2002-319434 and 2002-42874 propose disposing different polymer electrolytes on the positive electrode side and the negative electrode side to improve battery characteristics.

In addition, since the energy of the battery increases as the voltage of the battery increases, the heat resistance of the separator is also important. International Publication No. 2018/155287 proposes disposing a porous layer containing a heat-resistant resin to impart heat resistance to a separator.

However, in JP '434 and JP '874, different polymer electrolyte layers are used on the positive electrode side and the negative electrode side, but since the polymer electrolyte layers are gel polymers and the polymer electrolyte layers swell with the electrolytic solution, the different electrolytic solutions on the positive electrode side and the negative electrode side cannot be sufficiently separated. That is, electrolytic solutions having two different compositions cannot be used in combination, and a high voltage and a high capacity of the battery cannot be achieved.

In WO '287, the heat resistance is high, and the safety of the battery is improved, but when non-aqueous electrolytic solutions having two different compositions are used, the two non-aqueous electrolytic solutions are mixed because of the porous film, and it is not possible to achieve a high voltage and a high capacity of the battery.

Therefore, in view of the above problems, it could be helpful to provide a non-aqueous electrolyte secondary battery having a high degree of safety and a high battery voltage by using a separator that has a high resistance to heat-temperature film rupture, that is, a high meltdown temperature of a film, and can separate two different electrolytic solutions in a battery using non-aqueous electrolytic solutions having two different solvent compositions.

### SUMMARY

We thus provide:
(1) A non-aqueous electrolyte secondary battery including a positive electrode, a negative electrode, a non-aqueous electrolytic solution, and a separator, in which: an active material of the positive electrode is a lithium-containing transition metal oxide represented by a general formula LixMyOz (where M is at least one element selected from the group consisting of Ni, Co, Mn, Al, Mg, and Mo, and a composition ratio satisfies 0.8≤x≤1.3, 0.5≤y≤2, and 1≤z≤4); an active material of the negative electrode contains one or more compounds selected from the group consisting of a C-based compound, a Si-based compound, a Sn-based compound and metal lithium or metal lithium; the non-aqueous electrolytic solution contains two solvents, is separated by the separator, and has a composition of the non-aqueous electrolytic solution in contact with a negative electrode side and a composition of the non-aqueous electrolytic solution in contact with a positive electrode side different from each other; and
the separator is a polymer film having an air permeability of more than 10,000 seconds, an ionic conductance of 1×10⁻⁵ S/cm or more, and a contact angle between at least one surface of the separator and an organic solvent of 90° or more.
(2) The non-aqueous electrolyte secondary battery according to (1), in which the separator is a polymer film having an air permeability of more than 10,000 seconds, an ionic conductance of 1×10⁻⁵ S/cm or more, and a contact angle between at least one surface of the separator and a propylene carbonate liquid of 90° or more and a contact angle between at least one surface of the separator and a 1,2-dimethoxyethane liquid of 90° or more.
(3) The non-aqueous electrolyte secondary battery according to (1) or (2), in which the non-aqueous electrolytic solution contains solvents and an electrolyte, a HOMO energy of the solvent of the non-aqueous electrolytic solution in contact with the positive electrode side is −11.5 eV or less, and a LUMO energy of the solvent of the non-aqueous electrolytic solution in contact with the negative electrode side is 2.0 eV or more.
(4) The non-aqueous electrolyte secondary battery according to any one of (1) to (3), in which a change ratio of a contact angle between an organic solvent and the polymer film after 1 hour is less than 10%.
(5) The non-aqueous electrolyte secondary battery according to any one of (1) to (4), in which change ratios of contact angle between the polymer film and a propylene carbonate liquid after 1 hour and a contact angle between the polymer film and a 1,2-dimethoxyethane liquid after 1 hour are less than 10%.
(6) The non-aqueous electrolyte secondary battery according to any one of (1) to (5), in which the polymer film has an areal thermal shrinkage of 10% or less after heat treatment at 180° C. for 60 minutes.
(7) The non-aqueous electrolyte secondary battery according to any one of (1) to (6), in which the polymer film has a meltdown temperature of 300° C. or more.
(8) The non-aqueous electrolyte secondary battery according to any one of (1) to (7), in which the polymer film contains at least one polymer selected from the group consisting of an aromatic polyamide, an aromatic polyimide, and an aromatic polyamide-imide.

There is thus provided a non-aqueous electrolyte secondary battery in which non-aqueous electrolytic solutions contain two different solvents. In addition, a polymer film capable of separating two different non-aqueous electrolytic solutions with a separator is obtained. Thus, the non-aqueous electrolyte secondary battery configured using the polymer film as a separator can provide a non-aqueous electrolyte secondary battery having good heat resistance of the separator, a high degree of safety, and a high battery voltage, that is, a high voltage and a high capacity.

### DETAILED DESCRIPTION

A non-aqueous electrolyte secondary battery according to an example will be described in detail below.

Our non-aqueous electrolyte secondary battery includes a positive electrode, a negative electrode, a non-aqueous electrolytic solution, and a separator, in which: an active material of the positive electrode is a lithium-containing transition metal oxide represented by a general formula LixMyOz where M is at least one element selected from the group consisting of Ni, Co, Mn, Al, Mg, and Mo, and a composition ratio satisfies 0.8≤x≤1.3, 0.5≤y≤2, and 1≤z≤4; an active material of the negative electrode contains one or more compounds selected from the group consisting of a C-based compound, a Si-based compound, a Sn-based compound, and metal lithium or metal lithium; the non-aqueous electrolytic solution has solvent compositions different between a negative electrode side and a positive electrode side; and the separator is a polymer film having an air permeability of more than 10,000 seconds, an ionic conductance of 1×10⁻⁵ S/cm or more, and a contact angle of an organic solvent of 90° or more. As the organic solvent, a propylene carbonate liquid and a 1,2-dimethoxyethane liquid are preferably used.

The statement that the non-aqueous electrolytic solution has solvent compositions different between the negative electrode side and the positive electrode side means that the non-aqueous electrolytic solution contains two solvents and is separated by the separator, and the composition of the solvent of the non-aqueous electrolytic solution in contact with the negative electrode side is different from the composition of the non-aqueous electrolytic solution in contact with the positive electrode side.

The positive electrode, the negative electrode, the non-aqueous electrolytic solution, and the separator, which are constituent members, will be described in detail. Positive electrode

The positive electrode includes a positive electrode current collector and a positive electrode mixture layer formed on the positive electrode current collector. As the positive electrode current collector, for example, aluminum, an aluminum alloy, stainless steel or the like can be used. The positive electrode mixture layer contains a positive electrode active material and a binder.

The positive electrode active material may be a lithium-containing transition metal oxide represented by general formula LixMyOz where M is at least one element selected from the group consisting of Ni, Co, Mn, Al, Mg, and Mo, and the composition ratio satisfies 0.8≤x≤1.3, 0.5≤y≤2, and 1≤z≤4, and examples thereof include LiCoO₂, LiMn₂O₄, Li(Ni_{0.5}Co_{0.2}Mn_{0.3})O₂, Li(Ni_{0.8}Co_{0.1}Mn_{0.1})O₂, Li(Ni_{0.9}Co_{0.1})O₂, LiNiO₂, Li(Ni_{0.9}Co_{0.5}Mn_{0.025}Mg_{0.025})O₂, Li(Ni_{0.9}Co_{0.05}Al_{0.05})O₂, Li(Ni_{0.8}Co_{0.1}Mn_{0.08}Al_{0.01}Mg_{0.01})O₂, and Li(Ni_{0.8}Co_{0.1}Mn_{0.08}Mo_{0.02})O₂. The positive electrode is produced, for example, as follows. The positive electrode

active material is mixed with a conductive agent such as graphite and carbon black and a binder such as polyvinylidene fluoride to obtain a positive electrode mixture. Then, the positive electrode mixture is dispersed in a solvent such as N-methyl-2-pyrrolidone (NMP) to prepare a slurry. This is applied to both surfaces of the positive electrode current collector, the solvent is dried, and then smoothening by compression by roll pressing or the like is performed to produce the positive electrode.

### Negative Electrode

The negative electrode includes a negative electrode current collector and a negative electrode mixture layer formed on the negative electrode current collector. As the negative electrode current collector, for example, a negative electrode current collector made of copper, nickel, or stainless steel can be used. The negative electrode mixture layer contains a negative electrode active material and a binder.

The negative electrode active material may contain one or more compounds selected from the group consisting of a C-based compound, a Si-based compound, a Sn-based compound, and metal lithium or metal lithium. Each compound may be used singly, or a mixture of a plurality of compounds may be used.

Examples of the Sn-based compound include Sn, SnO₂, and Sn-R where R is any of alkali metals, alkaline earth metals, group 13 to 16 elements, transition metals, and rare earth elements or a combination thereof. However, Sn is excluded.

Examples of the Si-based compound include Si, SiOx (0<x<2), a Si-C composite, and a Si-Q alloy where Q is selected from the group consisting of an alkali metal, an alkaline earth metal, an element selected from groups 13 to 16 (an element selected from elements belonging to groups 13 to 16 of the periodic table) excluding Si, a transition metal, a rare earth element, and a combination thereof.

A specific Q or R element in Si-Q and Sn-R may be one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof. Among them, a Si-based compound is preferable, and SiOx (0<x<2) is more preferable.

Examples of the C-based compound include artificial graphite, natural graphite, hard carbon, and soft carbon. A mixture of the C-based compound and the Si-based compound or the Sn-based compound may be used.

The negative electrode is produced, for example, as follows. A negative electrode active material containing at least one of the C-based compound, the Si-based compound, and the Sn-based compound is mixed with a binder such as a styrene-butadiene copolymer, a polyimide, a polyamide-imide, and polyvinylidene fluoride to obtain a negative electrode mixture. Then, the negative electrode mixture is dispersed in a solvent such as N-methyl-2-pyrrolidone (NMP) and water to prepare a slurry. This is applied to both surfaces of the negative electrode current collector, the solvent is dried, and then smoothening by compression by roll pressing or the like is performed, whereby the negative electrode can be produced.

In addition, a negative electrode conductive auxiliary agent may be used as necessary. Examples of the negative electrode conductive auxiliary agent include acetylene black, ketjen black, a carbon nanotube, a fullerene, graphene, and a carbon fiber.

When the negative electrode active material is metal lithium, metal lithium by itself can be used to form the negative electrode, and production can be performed by forming and spraying lithium nanoparticles together with He gas to deposit the lithium nanoparticles on the negative electrode current collector by gas deposition. A laminated structure of metal lithium and the C-based compound is also possible.

### Non-Aqueous Electrolytic Solution

The non-aqueous electrolytic solution is constituted of a solvent and an electrolyte. As the non-aqueous electrolytic solution used in the example, nonaqueous electrolytic solutions containing solvents different between the negative electrode side and the positive electrode side are used. That is, the non-aqueous electrolytic solution contains two solvents, and the composition of the non-aqueous electrolytic solution in contact with the negative electrode side and the composition of the non-aqueous electrolytic solution in contact with the positive electrode side are different. The non-aqueous electrolytic solutions having different compositions include non-aqueous electrolytic solutions having different solvent compositions.

As the solvent, cyclic esters, chain esters, cyclic ethers, chain ethers, amides and the like are used, and specifically, organic solvents such as ethylene carbonate (EC), propylene carbonate (PC), butylene carbonate (BC), vinylene carbonate (VC), dimethyl carbonate (DMC), diethyl carbonate (DEC), methyl ethyl carbonate (MEC), γ-butyrolactone (γBL), 2-methyl-γ-butyrolactone, acetyl-γ-butyrolactone, γ-valerolactone, 1,2-dimethoxyethane (DME), 1,2-ethoxyethane, diethyl ether, ethylene glycol dialkyl ethers, diethylene glycol dialkyl ethers, triethylene glycol dialkyl ethers, tetraethylene glycol dialkyl ethers, dipropyl carbonate, methyl butyl carbonate, methyl propyl carbonate, ethyl butyl carbonate, ethyl propyl carbonate, butyl propyl carbonate, propionic acid alkyl esters, malonic acid dialkyl esters, acetic acid alkyl esters, tetrahydrofuran (THF), alkyltetrahydrofurans, dialkylalkyltetrahydrofurans, alkoxytetrahydrofurans, dialkoxytetrahy drofurans, 1,3-dioxolane, alkyl-1,3-dioxolanes, 1,4-dioxolane, 2-methyltetrahydrofuran, dimethylsulfoxide, 1,3-dioxolane, formamide, dimethylformamide, dioxolane, acetonitrile, nitromethane, methyl formate, methyl acetate, methyl propionate, ethyl propionate, phosphoric acid triesters, and N-methyl-2-pyrrolidone, and derivatives and mixtures thereof are preferably used.

The oxidation resistance and reduction resistance of the solvent are important when the solvent is used in the electrolytic solution. The oxidation resistance and reduction resistance of the solvent can be evaluated using the highest occupied molecular orbital (HOMO) energy and the lowest unoccupied molecular orbital (LUMO) energy according to the frontier orbital theory.

Examples of the solvent having a HOMO energy of −11.5 eV or less include cyclic esters and chain esters. A solvent having a HOMO energy of −11.5 eV or less is excellent in oxidation resistance but has a low LUMO energy and low reduction resistance. On the other hand, examples of the solvent having a LUMO energy of 2 eV or more include cyclic ethers, chain ethers, and amides. A solvent having a LUMO energy of 2.0 eV or more has excellent reduction resistance but has a high HOMO energy and low oxidation resistance. That is, there is no solvent that achieves both high oxidation resistance and high reduction resistance.

The non-aqueous electrolytic solution is constituted such that two solvents including a solvent excellent in oxidation resistance and a solvent excellent in reduction resistance are used as the solvents of the non-aqueous electrolytic solutions, and the two different non-aqueous electrolytic solutions are separated by the separator to not be mixed. At this time, two non-aqueous electrolytic solutions are used: a non-aqueous electrolytic solution in which the HOMO energy of the solvent constituting the non-aqueous electrolytic solution is −11.5 eV or less; and a non-aqueous electrolytic solution in which the LUMO energy of the solvent constituting the non-aqueous electrolytic solution is 2.0 eV or more.

Regarding the disposition of the two non-aqueous electrolytic solutions, it is preferable that the non-aqueous electrolytic solution in which the HOMO energy of the solvent constituting the non-aqueous electrolytic solution is −11.5 eV or less is disposed on the positive electrode side, and the non-aqueous electrolytic solution in which the LUMO energy of the solvent constituting the non-aqueous electrolytic solution is 2.0 eV or more is disposed on the negative electrode side. As described above, the two non-aqueous electrolytic solutions are separated by the separator to not be mixed and disposed on the positive electrode side and the negative electrode side, thereby achieving a high voltage of the battery. The lower limit of the absolute value of the HOMO energy of the solvent constituting the non-aqueous electrolytic solution in contact with the positive electrode side is preferably as large as possible since the HOMO energy is a negative value. The upper limit of the LOMO energy of the solvent constituting the non-aqueous electrolytic solution in contact with the negative electrode side is preferably as large as possible.

As the electrolyte contained in the non-aqueous electrolytic solution, a halide, perchlorate, thiocyanate, borofluoride, phosphofluoride, arsenofluoride, aluminofluoride, trifluoromethylsulfate or the like of an alkali metal, particularly lithium, is preferably used. For example, one or more salts such as lithium salts (electrolytes) such as lithium perchlorate (LiClO₄), lithium hexafluorophosphate (LiPF₆), lithium tetrafluoroborate (LiBF₄), lithium hexafluoroarsenate (LiAsF₆), lithium trifluoromethasulfonate (LiCF₃SO₃), and lithium bis(trifluoromethylsulfonyl)imide [LiN(CF₃SO₂)₂] can be used, but lithium hexafluorophosphate is preferable from the viewpoint of oxidation resistance and reduction resistance.

The amount of the electrolyte dissolved in the non-aqueous solvent is preferably 0.5 to 3.0 mol/L, particularly preferably 0.8 to 1.5 mol/L. The electrolytes contained in the two non-aqueous electrolytic solutions may be the same or different.

In the non-aqueous electrolytic solution, other additives may be used as necessary. Examples of the additives include vinylene carbonate, fluoroethylene carbonate, ethylene sulfite, 1,4-butane sultone, propane sultone, 2,4-difluoroanisole, biphenyl, and cyclohexylbenzene, and one or more of these may be used.

### Separator

The separator is a polymer film having an air permeability of more than 10,000 seconds, a contact angle of an organic solvent of 90° or more, and an ionic conductance of 1×10⁻⁵ S/cm or more.

Since the polymer film has an air permeability of more than 10,000 seconds, the non-aqueous electrolytic solutions can be separated in the battery using the two different non-aqueous electrolytic solutions. When the air permeability is more than 10,000 seconds, the separator can be regarded as a non-porous structure substantially having no continuous hole.

When the contact angle of the polymer film with the organic solvent is 90° or more, the polymer film does not swell with the non-aqueous electrolytic solutions, and the non-aqueous electrolytic solutions do not permeate the polymer film so that the two non-aqueous electrolytic solutions can be separated. We found that in a microporous film used for a separator, a contact angle with a solution tends to be large due to an influence of a surface structure of micropores, but the polymer film that separates the two different non-aqueous electrolytic solutions to prevent mixing has a pore-free structure so that the contact angle tends to be small. Depending on the combination of the polymer film and the organic solvent, the contact angle is less than 90°, the polymer film is wetted with the solvent, and the increase in voltage is reduced. The decrease in battery voltage or battery capacity can be evaluated by performing a cycle test in which charging and discharging are repeated.

In addition, it is preferable that the polymer film of the separator be not wetted with the organic solvents for a long time from the viewpoint of being able to separate the electrolytic solutions and maintaining the battery characteristics at the time of using the battery. Therefore, the change ratio in the contact angle of the polymer film with the organic solvent after 1 hour is preferably less than 10%, more preferably less than 7%. The contact angle is evaluated for each of the solvent having a HOMO energy of −11.5 eV or less and the solvent having a LUMO energy of 2.0 eV or more. Specifically, propylene carbonate can be used as the solvent having a HOMO energy of −11.5 eV or less, and 1,2-dimethoxyethane can be used as the solvent having a LUMO energy of 2.0 eV or more.

The polymer film has an ionic conductance, which is an index of the ionic conductivity of the separator, of 1×10⁻⁵ S/cm or more. Since the polymer film has a pore-free structure, the polymer film cannot be impregnated with the electrolytic solutions and does not swell with the electrolytic solutions, it is important from the viewpoint of battery characteristics that the polymer film has ionic conductivity.

Furthermore, the polymer film is required to have heat resistance, and the areal thermal shrinkage after heating at 180° C. for 60 minutes is preferably 10% or less, more preferably 5% or less, from the viewpoint of safety of the battery. In particular, when metal lithium is used for the negative electrode, since the spontaneous ignition temperature of metal lithium is 179° C., it is important from the viewpoint of battery safety that the thermal shrinkage at a temperature of the spontaneous ignition temperature or more is small.

The meltdown temperature of the polymer film is preferably 300° C. or more, more preferably 350° C. or more, from the viewpoint of the safety of the battery. The polymer film that achieves the separator will be described below.

As the polymer constituting the polymer film serving as the separator, a polymer having an aromatic ring on the main chain is suitable as a polymer having all of heat resistance, strength, and flexibility. Examples of such a polymer include aromatic polyamides (aramids), aromatic polyimides, aromatic polyamide-imides, aromatic polyether ketones, aromatic polyether ether ketones, aromatic polyarylates, aromatic polysulfones, aromatic polyether sulfones, aromatic polyether imides, and aromatic polycarbonates. In addition, a blend of a plurality of polymers may be used. In particular, it is preferable that the polymer film contains at least one polymer selected from the group consisting of an aromatic polyamide, an aromatic polyimide, and an aromatic polyamide-imide because such a polymer film is excellent in heat resistance and easily maintains high strength when being thinned. It is preferable that at least one polymer selected from the group consisting of an aromatic polyamide, an aromatic polyimide, and an aromatic polyamide-imide be contained in an amount of 30 to 100 mass %, more preferably 50 to 100 mass %, of the entire polymer film.

As a polymer that can be suitably used, a polymer having a structure of any one of Chemical Formulas (I) to (III) is preferably contained in the polymer constituting the film, and examples of the aromatic polyamide include a polymer having a repeating unit represented by Chemical Formula (I), examples of the aromatic polyimide include a polymer having a repeating unit represented by Chemical Formula (II), and examples of the aromatic polyamide-imide include a polymer having a repeating unit represented by Chemical Formula (III):

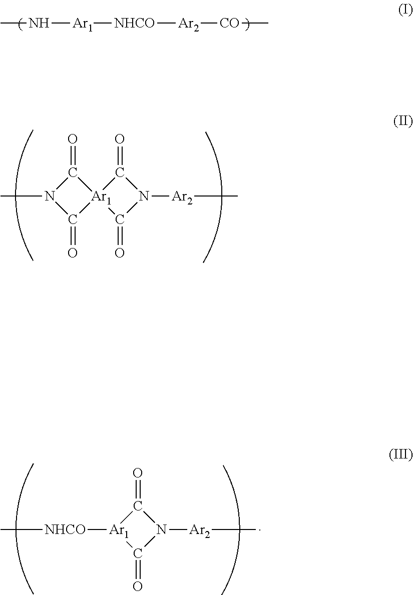

Ar₁ and/or Ar₂ in Chemical Formulas (I) to (III) are aromatic groups, each of which may be a single group or may be a plurality of groups to constitute a copolymer of multiple components. The bonds constituting the main chain on the aromatic ring may be either meta-orientation or para-orientation. Furthermore, part of the hydrogen atoms on the aromatic ring may be substituted with an arbitrary group.

As means of achieving both separation of the electrolytic solutions and heat resistance, and excellent ion conductivity, a method of transporting ions by hopping by controlling the polarity of the polymer can be mentioned.

When an aromatic polyamide (including an aromatic polyamic acid), an aromatic polyimide, or an aromatic polyamide-imide is used, a carbonyl group is included in the structure, and therefore the carbonyl group is often generally a site having high affinity with lithium ions.

Therefore, since a site having lower affinity with lithium ions than the carbonyl group is required for lithium ions to move in the polymer film, it is preferable that an ether bond or a thioether bond be included in the main chain or the side chain (in the main chain or on the side chain).

More preferably, it is preferable that an ether bond be included in the main chain or that at least one group of a carboxylic acid group, a carboxylate salt group, a sulfonic acid group, a sulfonate salt group, an alkoxy group, and a cyanate group be included as the substituent on the aromatic ring. More preferably, 25 to 100 mol % of the total of all groups of Ar₁ and Ar₂ in Chemical Formulas (I) to (III) is at least one group selected from groups represented by Chemical Formulas (IV) to (VI), and the above ratio is more preferably 50 to 100 mol %:

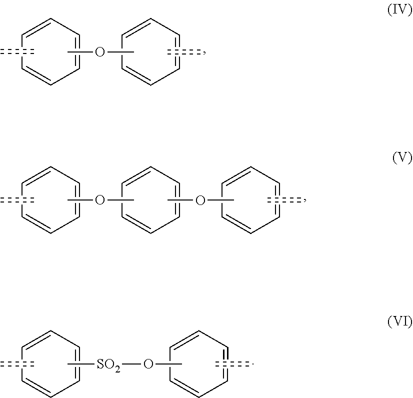

The double dashed lines in Chemical Formulas (IV) to (VI) each represent one or two bonds.

Part of the hydrogen atoms on the aromatic rings of Chemical Formulas (IV) to (VI) may be substituted with any group such as a halogen group such as fluorine, bromine, and chlorine, a nitro group, a cyano group, an alkyl group such as methyl, ethyl, and propyl, an alkoxy group such as methoxy, ethoxy, and propoxy, and a carboxylic acid group.

In addition, it is preferable to add a lithium salt to facilitate ion conduction in the polymer film, and it is more preferable to add a lithium salt having high dissociability of lithium ions having a large anion radius to further improve ion conductivity. As the lithium salt to be added, the same lithium salt as the solute contained in the electrolytic solutions can be used. For example, lithium perchlorate (LiClO₄), lithium hexafluorophosphate (LiPF 6), lithium tetrafluoro- borate (LiBF₄), lithium hexafluoroarsenate (LiAsF₆), lithium trifluoromethasulfonate (LiCF₃SO₃), and lithium bis(trifluoromethylsulfonyl)imide [LiN(CF₃SO₂)₂] are preferable, and addition of lithium trifluoromethasulfonate (LiCF₃SO₃) or lithium bis(trifluoromethylsulfonyl)imide [LiN(CF₃SO₂)₂] is preferable from the viewpoint of the anion radius and dissociability of lithium ions.

Next, a method of producing a polymer film as a separator will be described below.

### Synthesis of Polymer for Separator

First, a method of obtaining a polymer that can be used for the polymer film will be described by taking an aromatic polyamide and an aromatic polyimide as examples. Of course, the polymer that can be used and the polymerization method thereof are not limited thereto.

Various methods can be used as a method of obtaining an aromatic polyamide. For example, when a low-temperature solution polymerization method is used using an acid dichloride and a diamine as raw materials, synthesis is performed in a polar aprotic organic solvent such as N-methylpyrrolidone, N,N-dimethylacetamide, dimethylformamide, and dimethylsulfoxide. In solution polymerization, to obtain a polymer having a high molecular weight, the water content in the solvent used for polymerization is preferably 500 ppm or less (on a mass basis, the same applies hereinafter), more preferably 200 ppm or less.

As a method of obtaining an aromatic polyimide or an aromatic polyamic acid as a precursor thereof, for example, a synthesis method in which solution polymerization is performed using a tetracarboxylic anhydride and an aromatic diamine as raw materials in a polar aprotic organic solvent can be employed. Examples of the polar aprotic organic solvent include N-methyl-2-pyrrolidone, N,N-dimethylacetamide, dimethylformamide, and dimethylsulfoxide.

When both the tetracarboxylic anhydride and the aromatic diamine as raw materials are used in equal amounts, an ultrahigh molecular weight polymer may be produced, and therefore it is preferable to adjust the molar ratio so that one is 90.0 to 99.5 mol % of the other.

The inherent viscosity (ηinh) of the aromatic polyamide, the aromatic polyimide, or the aromatic polyamic acid as a precursor thereof is preferably 0.5 to 6.0 dl/g. When the inherent viscosity is less than 0.5 dl/g, the interchain bonding force due to entanglement of polymer molecular chains is reduced so that mechanical properties such as toughness and strength may be deteriorated, or thermal shrinkage may be increased. If the inherent viscosity exceeds 6.0 dl/g, the ion permeability may decrease.

### Preparation of Film-Forming Raw Material

Next, a film-forming raw liquid used in the process of producing the polymer film of a film-forming raw liquid will be described.

For the film-forming raw liquid, the polymer solution after polymerization may be used as it is, or the polymer may be isolated once and then redissolved in the above-described polar aprotic organic solvent or an inorganic solvent such as sulfuric acid.

The concentration of the polymer in the film-forming raw liquid is preferably 3 to 30 mass %, more preferably 5 to 20 mass %. The lithium salt described above is preferably added to the film-forming raw liquid from the viewpoint of improving ion conductivity. The amount of the lithium salt added is such that the molar ratio between lithium in the lithium salt and oxygen in the polymer is preferably 0.1 or more, more preferably 0.2 or more. Formation of polymer film for separator.

Next, a method of forming the polymer film will be described. The film-forming raw liquid prepared as described above can be formed into a film by what is called solution casting. Solution casting includes a dry-wet method, a dry method, a wet method, and the like, and film formation may be performed by any method. The dry-wet method will be described as an example. The polymer film may be formed directly on a substrate having pores or on an electrode to form a laminated composite, but here, a method of forming a film as a single film will be described.

In film formation by a dry-wet method, the film-forming raw liquid is extruded from a spinneret onto a support such as a drum, an endless belt, and a film to form a membranous material, and then the membranous material is dried until the membranous material has self-holding properties. The drying can be performed, for example, under conditions of 60 to 220° C. within 60 minutes. However, when a polyamic acid polymer is used and a film made of an aromatic polyamic acid is to be obtained without imidization, the drying temperature is preferably 60 to 150° C., more preferably 60 to 120° C.

The film after the dry process is peeled from the support and introduced into the wet process, desalted, desolventized and the like, and further stretched, dried, and heat-treated. The stretch ratio is preferably 0.8 to 8.0 in terms of the area stretch ratio (the area stretch ratio is defined as a value obtained by dividing the area of the film after stretching by the area of the film before stretching). A value of 1 or less means relaxation, more preferably 1.0 to 5.0. As the heat treatment, heat treatment is performed at a temperature of 80° C. to 500° C., preferably 150° C. to 400° C., for several seconds to several tens of minutes. However, when a polyamic acid polymer is used and a film made of a polyamic acid is to be obtained without imidization, the heat treatment temperature is preferably 80 to 150° C. More preferably, the temperature is set to 80 to 120° C. under reduced pressure.

### Non-Aqueous Electrolyte Secondary Battery

Examples of the form of the non-aqueous electrolyte secondary battery of the example include a coin battery, a laminated battery, a cylindrical battery, and a prismatic battery. To increase the capacity of the battery and to form a module by connecting a plurality of batteries, a laminated battery, a cylindrical battery, and a prismatic battery are particularly preferable.

As a method of producing a non-aqueous electrolyte secondary battery, for example, in a laminated battery, a cylindrical battery, or a prismatic battery, a positive electrode sheet, a separator, a negative electrode sheet, and a separator are superposed in this order and spirally wound to produce a wound body, or in a coin battery, a laminated battery, or a prismatic battery, a positive electrode sheet, a separator, a negative electrode sheet, and a separator having predetermined sizes are superposed and laminated in this order to produce a laminated body, the produced wound body or laminated body is filled in each battery case, leads of a positive electrode and a negative electrode are welded, then an electrolytic solution is injected into the battery case, and an opening of the battery case is sealed to complete the battery.

### EXAMPLES

Hereinafter, our batteries and methods will be described in detail by way of examples, but this disclosure is not limited to the examples. The measurement methods used in the examples will be shown below.

### Measurement Methods

### (1) Meltdown Temperature of Separator

A separator, that is, a polymer film, having a size of 50 mm×50 mm was cut out, the sample was sandwiched between two stainless steel plates each having a through hole of 12 mm at the center and further sandwiched between heating block plates each having a through hole of 12 mm at the center from both sides of the sample. A sphere made of tungsten carbide and having a diameter of 9.5 mm was placed in the through hole, the temperature of the heating block plates was raised at 5° C./min, and the temperature of the heating block plates when the polymer film was dissolved and the sphere dropped was measured. The test was performed five times, and the average value was taken as the meltdown temperature (° C.).

### (2) Air Permeability of Separator

Measurement was performed in accordance with JIS P 8117 (1998) using an Oken type air permeability meter EGO-1T (manufactured by ASAHI SEIKO CO., LTD.). The measurement limit of the air permeability is 10,000 seconds. When the air permeability exceeds 10,000 seconds, the separator can be regarded as a substantially non-porous structure.

### (3) Ionic Conductance (Unit: S/cm)

The polymer film was immersed in an electrolytic solution (1M LiTFSI ethylene carbonate (EC)/diethyl carbonate (DEC)=1/1, manufactured by Mitsui Chemicals, Inc.) for 8 hours, then temporarily pulled up, and placed on a SUS 304 electrode to cover an electrode portion, 5 mL of the electrolytic solution was added dropwise, and then the polymer film was sandwiched with another SUS electrode to produce a laminate of electrode/polymer film/electrode. An evaluation cell was produced by fixing the laminate with a silicon plate to prevent displacement.

For the produced cell, the AC impedance was measured under the conditions of an amplitude of 10 mV and frequencies of 1 MHz to 10 mHz with an electrochemical tester model number: SP-150 (manufactured by BioLogic) at 25° C., and the resistance value was read from the graph plotted on a complex plane and substituted into the following equation to calculate the ionic conductance. Measurements were made five times, and the calculated average value was taken as the ionic conductance.

σ=d1/A·R
σ: Ionic conductance (S/cm)
d1: Thickness (cm) of polymer film (before immersion in electrolytic solution)
A: Area of electrode (cm²)
R: Resistance (Ω).

### (4) Contact Angle Between Separator and Organic Solvent and Change Ratio Thereof

First, a polymer film as a separator is left standing for 24 hours in an atmosphere at a room temperature of 23° C. and a relative humidity of 65%. Thereafter, under the same atmosphere, 1 μL of each of two organic solvents of propylene carbonate (PC) and 1,2-dimethoxyethane (DME) is added dropwise to the separator, and the contact angle after 10 seconds is measured 5 times each with a contact angle meter DropMaster model number DM-501 (manufactured by Kyowa Interface Science Co., Ltd.). The average of the measured values at three out of five points excluding the maximum and minimum values was used as the contact angle of each organic solvent.

In addition, the contact angle 1 hour after dropwise addition was measured in the same manner, and the change ratio (%) from the contact angle 10 seconds after dropwise addition was evaluated using the following formula:

(Contact angle 10 seconds after dropwise addition−contact angle 1 hour after dropwise addition)/(contact angle 10 seconds after dropwise addition)×100.

When the contact angle 10 seconds after dropwise addition is compared with the contact angle 1 hour after the dropwise addition, the contact angle 10 seconds after dropwise addition is often larger. The change ratio (%) is obtained by subtracting the smaller contact angle from the larger contact angle so that the difference in contact angle will be a positive value and dividing the difference by the contact angle 10 seconds after dropwise addition.

### (5) Areal Thermal Shrinkage of Polymer Film

A piece having a size of 50 mm×50 mm was cut out and used as a sample. The length of each side in the longitudinal direction and the width direction of the cut sample was measured, and the length in the longitudinal direction L_{MD1}=50 (mm) and the length in the width direction L_{TD1}=50 (mm) were set. The sample was allowed to stand in a hot air oven heated to 180° C. for 60 minutes to be subjected to heat treatment, and then allowed to cool. The dimension of the portion where the length was the shortest in each of the longitudinal direction and the width direction of the sample taken out was measured and defined as a length LMD2 (mm) in the longitudinal direction and a length LTD2 (mm) in the width direction. The shrinkage was calculated on the basis of the following equation:

Areal thermal shrinkage (%)=(L_{MD1}×L_{TD1}−L_{MD2}×L_{TD2})/L_{MD1}×L_{TD1}×100.

Measurements were performed five times per sample, and the obtained values were averaged.
(6) Inherent Viscosity of Polymer (Unit: dl/g)

A polymer was dissolved at a concentration of 0.5 g/dl in N-methylpyrrolidone (NMP) containing 2.5 wt% of lithium bromide (LiBr), and the flow time was measured at 30° C. using an Ubbelohde viscometer. The flow time of the blank LiBr 2.5 wt %/NMP in which the polymer was not dissolved was also measured in the same manner, and the viscosity η (dl/g) was calculated using the following equation:

η=[ln (t/t0)]/0.5
t0: Flow time of blank (S)
t: Flow time of sample (S).

### (7) Charge-Discharge Cycle Characteristics

The non-aqueous electrolyte secondary batteries produced in Examples and Comparative Examples were subjected to a charge-discharge cycle characteristic test according to the following procedure to calculate a discharge capacity retention ratio. Charge-discharge cycle characteristics are one of evaluation items of a battery voltage and a battery capacity, and a secondary battery in which charge-discharge cycle characteristics are stable, a discharge capacity retention ratio is less likely to decrease, and a discharge capacity can be maintained is favorable.

In the cycle test, charging and discharging were repeated 150 times at a temperature of 25° C. with charging and discharging as 1 cycle, constant current charging at 0.5 C and 5 V as charging conditions, and constant current discharging at 0.5 C and 2.8 V as discharging conditions. The discharge capacities obtained in the 1st cycle and the 150th cycle are measured, and the discharge capacity retention ratio (%) is calculated by the following formula:

(Discharge capacity at 150th cycle)/(discharge capacity at 1st cycle)×100.

Five tests were performed on the non-aqueous electrolyte secondary batteries produced in each of examples and comparative examples, and the average of three measurement results excluding the maximum and minimum discharge capacity retention ratios was taken as the discharge capacity retention ratio.

The discharge capacity retention ratio was evaluated with the following ranks. A secondary battery having a discharge capacity retention ratio of 60% or more, that is, a secondary battery of rank S, A, or B, is good.
The discharge capacity retention ratio is less than 60%: C
The discharge capacity retention ratio is 60% or more and less than 70%: B
The discharge capacity retention ratio is 70% or more and less than 75%: A
The discharge capacity retention ratio is 75% or more: S.

### Example 1

A separator and a non-aqueous electrolyte secondary battery were produced as follows. Table 1 shows the physical properties of the separator and the characteristics of the non-aqueous electrolyte secondary battery.

### Production of Positive Electrode

First, in a dry atmosphere, 100 parts by mass of Li(Ni_{0.5}Co_{0.2}Mn_{0.3})O₂ as a positive electrode active material, 2 parts by mass of acetylene black as a conductive auxiliary agent, 2 parts by mass of graphite as a conductive auxiliary agent, 4 parts by mass of polyvinylidene fluoride (PVDF) as a binder (solid content was supplied as an N-methylpyrrolidone (NMP) solution), and maleic anhydride as an additive were mixed with NMP as a solvent to be uniform, thereby preparing paste containing a positive electrode mixture. Next, the obtained paste containing a positive electrode mixture was intermittently applied to both surfaces of a positive electrode current collector made of an aluminum foil having a thickness of 20 μm and dried, and then calendering treatment was performed to adjust the thickness of the positive electrode mixture layer so that the total thickness was 169 μm, and cutting was performed so that the length was 504 mm and the width was 56 mm to produce a positive electrode. Further, a lead portion was formed by welding a tab to an exposed portion of the aluminum foil of the positive electrode. Production of negative electrode

With ion-exchanged water as a solvent having a specific conductivity of 2.0×10⁵ Ω/cm or more, 100 parts by mass of graphite as a negative electrode active material, 1 part by mass of carboxymethyl cellulose (CMC) (solid content was supplied as a 1-mass % aqueous solution) and 3 parts by mass of styrene-butadiene rubber (SBR) (solid content was supplied as a 3-mass % aqueous solution) as binders, and 5 mass % of carbon fiber as a conductive auxiliary agent were mixed to prepare paste containing a negative electrode mixture. Next, the obtained paste containing a negative electrode mixture was intermittently applied to both surfaces of a negative electrode current collector made of a copper foil having a thickness of 16.5 μm and dried, and then calendering treatment was performed to adjust the thickness of the negative electrode mixture layer so that the total thickness was 148 μm, and cutting was performed so that the length was 460 mm and the width was 58 mm to produce a negative electrode. Further, a lead portion was formed by welding a tab to an exposed portion of the copper foil of the negative electrode.

### Production of Electrolytic Solution

A non-aqueous electrolytic solution containing a solvent constituting the non-aqueous electrolytic solution having a HOMO energy of −11.5 eV or less was produced as follows. In 1 L of a mixed solvent of ethylene carbonate (EC) and propylene carbonate (PC) at a volume ratio of 1:1, 1.0 mol of lithium hexafluorophosphate (LiPF6) was dissolved to produce a mixed solution, and 2 parts by mass of vinylene carbonate (VC) was further added to 100 parts by mass of the mixed solution to prepare a non-aqueous electrolytic solution A.

A non-aqueous electrolytic solution containing a solvent constituting the non-aqueous electrolytic solution having a LUMO energy of 2 eV or more was produced as follows. In 1,2-dimethoxyethane (DME), 1.0 mol of lithium hexafluorophosphate (LiPF₆) was dissolved to produce a mixed solution, and 2 parts by mass of vinylene carbonate (VC) was further added to 100 parts by mass of the mixed solution to prepare a non-aqueous electrolytic solution B.

### Production of Separator

4,4′-Diaminodiphenyl ether as a diamine was dissolved in dehydrated N-methyl-2-pyrrolidone under a nitrogen stream, and the solution was cooled to 30° C. or less. 2-Chloroterephthaloyl chloride corresponding to 99 mol % with respect to the total amount of the diamine was added to the solution over 30 minutes while the inside of the system was kept at 30° C. or less under a nitrogen stream, and after the whole was added, stirring was performed for about 2 hours to perform polymerization to form an aromatic polyamide. The obtained polymerization solution was neutralized with 97 mol % of lithium carbonate and 6 mol % of diethanolamine based on the total amount of the acid chloride to obtain a polymer solution A. The obtained polymer had an inherent viscosity 11 of 2.5 dl/g.

Lithium bis(trifluoromethylsulfonyl)imide [LiN(CF₃SO₂)₂] as a lithium salt was added to the resulting polymer solution so that the molar ratio between lithium in the lithium salt and oxygen in the polymer was 0.2, and the mixture was stirred and defoamed using a mixer (Manufactured by Thinky Corporation, model number: AR-250) to obtain a homogeneous transparent solution. The obtained homogeneous mixed solution of the polymer and the lithium salt was applied on a glass plate as a support to form a film and dried at a hot air temperature of 60° C. until the polymer film had self-supporting properties, and then the polymer film was peeled off from the support. Subsequently, the film was introduced into a water bath at 25° C. to extract the solvent, the neutralized salt, and the like. Subsequently, water on the surface of the obtained polymer film in a water-containing state was wiped off, and then heat treatment was performed for 1 minute in a tenter chamber at a temperature of 180° C. to obtain a polymer film having a thickness of 5 μm.

### Assembly of Battery

In a dry atmosphere, the positive electrode and the negative electrode were disposed in a 2-compartment cell (SB-100B manufactured by EC FRONTIER CO., LTD.), the separator was disposed in the 2-compartment cell, the non-aqueous electrolytic solution A was injected to the positive electrode side, and the non-aqueous electrolytic solution B was injected to the negative electrode side to produce a non-aqueous electrolyte secondary battery (lithium ion secondary battery) having a battery capacity of 3 mAh.

Table 1 shows the characteristics of the polymer film of the obtained separator. The contact angle between the polymer film and the propylene carbonate (PC) liquid 10 seconds after dropwise addition was 110° , and the contact angle 1 hour after dropwise addition was 108°. The contact angle between the polymer film and the 1,2-dimethoxyethane (DME) liquid 10 seconds after dropwise addition was 105°, and the contact angle 1 hour after dropwise addition was 103°. The change ratios in the contact angles of the PC liquid and the DME liquid were both 2%.

Table 1 shows the evaluation results of the obtained battery. The charge-discharge cycle characteristics were as good as rank S: 75% or more.

### Example 2

A non-aqueous electrolyte secondary battery was produced in the same manner as in Example 1 except that the lithium salt was changed to lithium trifluoromethasulfonate (LiCF₃SO₃) in the production of the separator. Table 1 shows the evaluation results of the obtained battery.

### Example 3

A non-aqueous electrolyte secondary battery was produced in the same manner as in Example 1 except that the negative electrode mixture layer was changed to a lithium metal foil (thickness per one surface: 30 μm) in the production of the negative electrode. Table 1 shows the evaluation results of the obtained battery.

### Example 4

A secondary battery was produced in the same manner as in Example 1 except that lithium bis(trifluoromethylsulfonyl)imide [LiN(CF₃SO₂)₂] as a lithium salt was added so that the molar ratio between lithium in the lithium salt and oxygen in the polymer was 0.1 in the production of the separator. Table 1 shows the evaluation results of the obtained battery.

### Example 5

In the production of the separator, 4,4′-diaminodiphenyl ether as a diamine was dissolved in dehydrated N-methyl-2-pyrrolidone under a nitrogen stream, and the solution was cooled to 30° C. or less. 2-Chloroterephthaloyl chloride corresponding to 99.5 mol % with respect to the total amount of the diamine was added to the solution over 30 minutes while the inside of the system was kept at 30° C. or less under a nitrogen stream, and after the whole was added, stirring was performed for about 2 hours to perform polymerization to form an aromatic polyamide. The obtained polymerization solution was neutralized with 97 mol % of lithium carbonate and 6 mol % of diethanolamine based on the total amount of the acid chloride to obtain a polymer solution B. The obtained polymer had an inherent viscosity 11 of 3.5 dl/g. A secondary battery was produced in the same manner as in Example 1 except that the obtained polymer solution B was used. Table 1 shows the evaluation results of the obtained battery.

### Example 6

A secondary battery was produced in the same manner as in Example 1 except that, as the non-aqueous electrolytic solution in which the HOMO energy of the solvent constituting the non-aqueous electrolytic solution was −11.5 eV or less, 1.0 mol of lithium hexafluorophosphate (LiP₆) was dissolved in 1 L of EC to produce a mixed solution, 2 parts by mass of vinylene carbonate (VC) was further added to 100 parts by mass of the mixed solution to prepare a non-aqueous electrolytic solution C, and the non-aqueous electrolytic solution C was used on the positive electrode side. Table 1 shows the evaluation results of the obtained battery.

### Example 7

In the production of the separator, 4,4′-diaminodiphenyl ether as a diamine was dissolved in dehydrated N-methyl-2-pyrrolidone under a nitrogen stream, and the solution was cooled to 30° C. or less. 2-Chloroterephthaloyl chloride corresponding to 97 mol % with respect to the total amount of the diamine was added to the solution over 30 minutes while the inside of the system was kept at 30° C. or less under a nitrogen stream, and after the whole was added, stirring was performed for about 2 hours to perform polymerization to form an aromatic polyamide. The obtained polymerization solution was neutralized with 97 mol % of lithium carbonate and 6 mol % of diethanolamine based on the total amount of the acid chloride to obtain a polymer solution C. The obtained polymer had an inherent viscosity 11 of 1.5 dl/g. A secondary battery was produced in the same manner as in Example 1 except that the obtained polymer solution C was used. Table 1 shows the evaluation results of the obtained battery.

### Comparative Example 1

A non-aqueous electrolyte secondary battery was produced in the same manner as in Example 1 except that both the electrolytic solution on the positive electrode side and the electrolytic solution on the negative electrode side were changed to the non-aqueous electrolytic solution A. Table 1 shows the evaluation results of the obtained battery.

### Comparative Example 2

A non-aqueous electrolyte secondary battery was produced in the same manner as in Example 1 except that both the electrolytic solution on the positive electrode side and the electrolytic solution on the negative electrode side were changed to the non-aqueous electrolytic solution B. Table 1 shows the evaluation results of the obtained battery.

### Comparative Example 3

A non-aqueous electrolyte secondary battery was produced in the same manner as in Example 1 except that a cellulose nonwoven fabric (thickness: 40 μm, density: 0.40 g/cm³) was used as the separator. The non-woven fabric was produced with a Fourdrinier paper machine using 100 mass% of lyocell fiber, which is regenerated cellulose fiber. Table 1 shows the evaluation results of the obtained battery.

### Comparative Example 4

A non-aqueous electrolyte secondary battery was produced in the same manner as in Example 3 except that a change was made to a polymer solution alone containing no lithium salt in the production of the separator. Table 1 shows the evaluation results of the obtained battery.

TABLE 1

| | | | | | Change ratio of | | Areal | | [Charge- |
|---|---|---|---|---|---|---|---|---|---|
| | Air | Ionic | Contact angle | | contact angle | | thermal | Meltdown | discharge cycle |
| | permeability | conductance | PC | DME | PC | DME | shrinkage | temperature | characteristics] |
| | (Sec) | (S/cm) | (°) | (°) | (%) | (%) | (%) | (° C.) | — |
| Example 1 | >10000 | 2 × 10⁻⁵ | 110 | 105 | 2 | 2 | 4.5 | 430 | S |
| Example 2 | >10000 | 1.5 × 10⁻⁵ | 105 | 105 | 3 | 3 | 6 | 410 | B |
| Example 3 | >10000 | 2 × 10⁻⁵ | 110 | 105 | 2 | 2 | 4.5 | 430 | A |
| Example 4 | >10000 | 1 × 10⁻⁵ | 115 | 110 | 1.5 | 1.5 | 4 | 435 | B |
| Example 5 | >10000 | 1.8 × 10⁻⁵ | 120 | 115 | 1.5 | 1.5 | 3 | 440 | A |
| Example 6 | >10000 | 2 × 10⁻⁵ | 110 | 105 | 2 | 2 | 4.5 | 430 | A |
| Example 7 | >10000 | 2.5 × 10⁻⁵ | 100 | 95 | 6 | 6 | 12 | 395 | B |
| Comparative | >10000 | 2 × 10⁻⁵ | 110 | 105 | 2 | 2 | 4.5 | 430 | C |
| Example 1 | | | | | | | | | |
| Comparative | >10000 | 2 × 10⁻⁵ | 110 | 105 | 2 | 2 | 4.5 | 430 | C |
| Example 2 | | | | | | | | | |
| Comparative | 10 | 9 × 10⁻⁴ | 50 | 45 | 40 | 35 | 15 | 180 | C |
| Example 3 | | | | | | | | | |
| Comparative | >10000 | 1 × 10⁻⁹ | 115 | 110 | 1 | 2 | 2 | 435 | C |
| Example 4 | | | | | | | | | |

Table 1 shows that Examples 1 to 7 each included non-aqueous electrolytic solutions having two different solvent compositions and had the contact angles of the organic solvents of 90° or more in the characteristics of the polymer film of the separator, and the non-aqueous electrolyte secondary battery exhibits good cycle characteristics. On the other hand, in Comparative Examples 1 and 2, the non-aqueous electrolytic solution had one solvent composition, and the cycle characteristics of the non-aqueous electrolyte secondary battery were not sufficient. In Comparative Example 3, the contact angles of the organic solvents in the characteristics of the polymer film of the separator were less than 90°, the non-aqueous electrolytic solutions having two different solvent compositions could not be separated, and the cycle characteristics of the non-aqueous electrolyte secondary battery were not sufficient. In Comparative Example 4, the ionic conductance of the polymer film was not sufficient, and the cycle characteristics of the non-aqueous electrolyte secondary battery were not sufficient.

1-8. (canceled)

9. A non-aqueous electrolyte secondary battery comprising:
a positive electrode;
a negative electrode;
a non-aqueous electrolytic solution; and
a separator,
wherein an active material of the positive electrode is a lithium-containing transition metal oxide represented by general formula LixMyOz, where M is at least one element selected from the group consisting of Ni, Co, Mn, Al, Mg, and Mo, and a composition ratio satisfies 0.8≤x≤1.3, 0.5≤y≤2, and 1≤z≤4,
an active material of the negative electrode contains one or more compounds selected from the group consisting of a C-based compound, a Si-based compound, a Sn-based compound and metal lithium or metal lithium,
the non-aqueous electrolytic solution contains two solvents, is separated by the separator, and has a composition of the non-aqueous electrolytic solution in contact with a negative electrode side and a composition of the non-aqueous electrolytic solution in contact with a positive electrode side different from each other, and
the separator is a polymer film having an air permeability of more than 10,000 seconds, an ionic conductance of 1×10⁻⁵ S/cm or more, and a contact angle between at least one surface of the separator and an organic solvent of 90° or more.

10. The non-aqueous electrolyte secondary battery according to claim 9, wherein the separator is a polymer film having an air permeability of more than 10,000 seconds, an ionic conductance of 1×10⁻⁵ S/cm or more, and a contact angle between at least one surface of the separator and a propylene carbonate liquid of 90° or more and a contact angle between at least one surface of the separator and a 1,2-dimethoxyethane liquid of 90° or more.

11. The non-aqueous electrolyte secondary battery according to claim 9, wherein
the non-aqueous electrolytic solution contains solvents and an electrolyte,
a HOMO energy of the solvent of the non-aqueous electrolytic solution in contact with the positive electrode side is −11.5 eV or less, and
a LUMO energy of the solvent of the non-aqueous electrolytic solution in contact with the negative electrode side is 2.0 eV or more.

12. The non-aqueous electrolyte secondary battery according to claim 9, wherein a change ratio of a contact angle between an organic solvent and the polymer film after 1 hour is less than 10%.

13. The non-aqueous electrolyte secondary battery according to claim 9, wherein change ratios of contact angle between the polymer film and a propylene carbonate liquid after 1 hour and a contact angle between the polymer film and a 1,2-dimethoxyethane liquid after 1 hour are less than 10%.

14. The non-aqueous electrolyte secondary battery according to claim 9, wherein the polymer film has an areal thermal shrinkage of 10% or less after heat treatment at 180° C. for 60 minutes.

15. The non-aqueous electrolyte secondary battery according to claim 9, wherein the polymer film has a meltdown temperature of 300° C. or more.

16. The non-aqueous electrolyte secondary battery according to claim 9, wherein the polymer film contains at least one polymer selected from the group consisting of an aromatic polyamide, an aromatic polyimide, and an aromatic polyamide-imide.
